(19) United States
(12) Patent Application Publication
(10) Pub. No.: US 2009/0028122 A1
(43) Pub. Date: Jan. 29, 2009

(54) WIRELESS LAN TERMINAL ALLOWING ANOTHER PROCESSING IN ITS WAITING OR IDLE STATE

(75) Inventor: Noriyoshi IKEDA, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/177,190

(22) Filed: Jul. 22, 2008

(30) Foreign Application Priority Data
Jul. 25, 2007 (JP) 2007-193076

(51) Int. Cl. H04Q 7/24

(52) U.S. Cl. 370/338

(57) ABSTRACT

Wireless LAN (Local Area Network) terminals are provided for executing a four-way handshaking procedure when they communicate with one another directly in a wireless ad hoc network mode. Each of the wireless LAN terminals may include a state processor which takes action in accordance with a communication state of its own wireless LAN terminal, and, upon sending a message during the four-way handshaking procedure, issues sending-completion information that indicates completion of the sending. The terminal may further include a state manager which, based on the sending-completion information, causes the communication state to be in a waiting state so that even during the four-way handshaking procedure, a message in processing procedure other than the message sent during the four-way handshaking procedure can be sent and received.

### BACKGROUND OF THE INVENTION

1. Field of the Invention

The present invention relates to a wireless LAN (Local Area Network) terminal, and more particularly to a wireless LAN terminal that sends and receives encrypted data to and from each other by radio, and a communication method therefor.

2. Description of the Background Art

In LAN systems, when two pieces of LAN equipment, such as a LAN terminal and a LAN base station, communicate with each other, they have as the security function a shared secret key that only both can know, and are able to transmit encrypted data generated using this secret key, by radio or through wire lines.

For example, in a wireless LAN system, random numbers are exchanged during the four-way handshake defined by the IEEE 802.11i standard, and based on a random number acquired, a secret key can be generated.

According to the wireless LAN system, two pieces of communications equipment have a pre-shared key (PSK) at the start of a connection, and acquire a random number in common by sending and receiving four messages, i.e. parameters (random numbers) necessary to generate a secret key, during the four-way handshake, employing four EAPOL (Extensible Authentication Protocol over LAN) frames. Then, the two pieces of communications equipment, based on the random number and pre-shared key, etc., are able to generate a secret key PTK (Pairwise Transient Key).

Particularly, when two pieces of wireless LAN equipment operate in a wireless ad hoc networkmode that directly transmits and receives wireless signals without a wire LAN base station to establish a connection, the four-way handshake is performed with one of the two pieces of wireless LAN equipment functioning as a wireless LAN base station, and then it is again performed with the other of the two functioning as a wireless LAN base station, whereby they generate a shared secret key PTK securely.

By the way, Japanese patent laid-open publication No. 198324/1997 discloses a data transfer controller that, in exchange of data with peripheral equipment, is capable of controlling the data transfer timing by performing transmission and reception of data four times, i.e. by performing the four-way handshake.

However, in conventional wireless LAN systems, particularly when two wireless LAN terminals operate in the wireless ad hoc network mode and transmit and receive wireless signals directly without a wireless LAN base station to establish a connection, normally, processes are continuously performed and therefore the processing capacity of each wireless LAN terminal is occupied by these processes until communication is established, so that other processes cannot be performed any longer with great efficiency.

For instance, in executing the four-way handshaking procedure twice, the second procedure cannot be initiated until the first procedure is completed. In addition, until the second procedure is completed, messages in another procedure cannot be received.

### SUMMARY OF THE INVENTION

It is an object of the present invention to provide a wireless LAN terminal and a communication method therefor that are capable of efficiently transmitting and receiving signals in a wireless ad hoc network mode.

In accordance with the present invention, there is provided a wireless LAN (Local Area Network) terminal for executing a four-way handshaking procedure when it directly communicates with another wireless LAN terminal in a wireless ad hoc network mode. The wireless LAN terminal includes a state processor which takes action in accordance with a communication state of the wireless LAN terminal and, upon sending a message during the four-way handshaking procedure, issues sending-completion information that indicates completion of the sending; and a state manager which is operative in response to the sending-completion information to cause the communication state to be in a waiting state to thereby allow, during the four-way handshaking procedure, a message in processing other than the message sent during the four-way handshaking procedure to be sent or received.

In addition, there is provided a method of executing a four-way handshaking procedure when a wireless LAN (Local Area Network) terminal directly communicates with another wireless LAN terminal in a wireless ad hoc network mode. The method includes a state processing step of taking action in accordance with a communication state of the wireless LAN terminal, and issuing, upon sending a message during the four-way handshaking procedure, sending-completion information that indicates completion of the sending; and a state managing step of causing, based on the sending-completion information, the communication state to be in a waiting state to thereby allow, during the four-way handshaking procedure, a message in processing other than the message sent during the four-way handshaking procedure to be sent or received.

According to the wireless LAN terminal of the present invention, the wireless LAN terminal performs the four-way handshaking procedure to communicate with the mating wireless LAN terminal with which communication is to be established. When a plurality of messages are sent and received between the two terminals during the four-way handshaking procedure, the wireless LAN terminal manages its communication state such as transmission and reception in such a manner that the communication state is always switched to a waiting state after sending a message. Since this makes it possible for another task to interrupt the four-way handshaking procedure, the establishment of communication between two or more wireless LAN terminals can be performed in parallel and thus efficient transmission and reception processing becomes possible.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing two wireless LAN terminals in accordance with a preferred embodiment of the present invention;

FIG. 2 is a flowchart showing how the communication state of each of the two wireless LAN terminals shown in FIG. 1 changes during a four-way handshaking procedure;

FIG. 3 is a sequence chart showing how the two wireless LAN terminals send and receive messages during the four-way handshaking procedure;

FIG. 4 is a sequence chart showing how the two wireless LAN terminals accept messages in a different processing procedure during the four-way handshaking procedure; and

FIG. 5 is a sequence chart showing a prior art four-way handshaking procedure.

### DESCRIPTION OF THE PREFERRED EMBODIMENT

Referring initially to FIG. 1, there is shown a preferred embodiment of a wireless LAN terminal of the present invention. The wireless LAN terminal 10 may be employed in a wireless LAN system 30, in which the terminal 10 is adapted to send and receive wireless signals to and from another wireless LAN terminal 12 without a wireless LAN base station to establish a wireless LAN connection. Note that parts or elements which are not directly relevant for understanding the present invention will not be shown for avoiding redundancy.

In the preferred embodiment, the wireless LAN system 30 in fact includes a number of wireless terminals 10 and 12, but FIG. 1 shows only two wireless LAN terminals 10 and 12 so that it does not become complicated. In addition, they may be of like structure and function, and thus only the wireless LAN terminal 10 is shown with its internal configuration, and a detailed illustration of the wireless LAN terminal 12 is not be given.

In the preferred embodiment, while it is standard for wireless LAN equipment such as the wireless LAN terminals 10 and 12 to perform communication through a wireless LAN base station, the wireless LAN terminals 10 and 12 can operate in a wireless ad hoc network mode to transmit and receive wireless signals directly without such a wireless LAN base station. In this case, the wireless LAN terminal 10, in order to perform encrypted-data communication with the mating wireless LAN terminal 12 with which communication is to be established, is adapted to generate a secret key that only both can know, and send data encrypted using this secret key. In addition, the wireless LAN terminal 10, in distributing an encryption key to the mating wireless LAN terminal 12, is adapted to have a pre-shared key beforehand, acquire a random number common to both by exchanging random numbers during the four-way handshake, and generate a secret key based on the pre-shared key and random number. That is to say, during a single four-way handshaking procedure, signals are sent and received four times between the wireless LAN terminals 10 and 12 by using four EAPOL frames.

In the preferred embodiment, the wireless LAN terminal 10 is constituted by a state manager 14, a state analyzer 16, and a state processor 18, which are interconnected as illustrated.

The state manager 14 is adapted to manage the communication state of transmission and reception in the wireless LAN terminal 10 in accordance with an external message received. More specifically, as the communication state, the state manager 14 holds either one of a “receiving” state for receiving a message, a “sending” state for sending a message, a “waiting”, or interrupt, state and an “idle” state. Only when the wireless LAN terminal 10 is in its idle or waiting state, it accepts reception of an external message.

The state manager 14 is also adapted to send a message signal 100, such as a wireless signal received, to the state analyzer 16 in the form of message signal 102. The state manager 14 is further adapted to receive an analysis result information signal 104 sent from the state analyzer 16 and, based on the analysis result information signal 104, determine whether or not the message signal 100 contains a message that can be normally processed. When the message signal 100 is determined to be processable, the state manager 14 sends it to the state processor 18 as a message information signal 106.

For example, when the communication state is the sending state, in response to a sending-completion information signal 108 from the state processor 18, the state manager 14 switches its sending state to its waiting state so that it can receive a next message signal.

The state analyzer 16 is adapted to analyze a message type for the message signal 102 sent from the state manager 14, for example, by the use of a dispatch table. A result 104 from this analysis is sent to the state manager 14.

The state processor 18 is adapted to process the message information signal 106 sent from the state manager 14 in accordance with the communication state. For instance, when the wireless LAN terminal 10 is in the sending state, the state processor 18 sends a receiving-response message 110 based on the processing result to outside the wireless LAN terminal 10, and sends a sending-completion information signal 108, which indicates the completion of the sending, to the state manager 14 to inform it that reception of a next message signal has become possible.

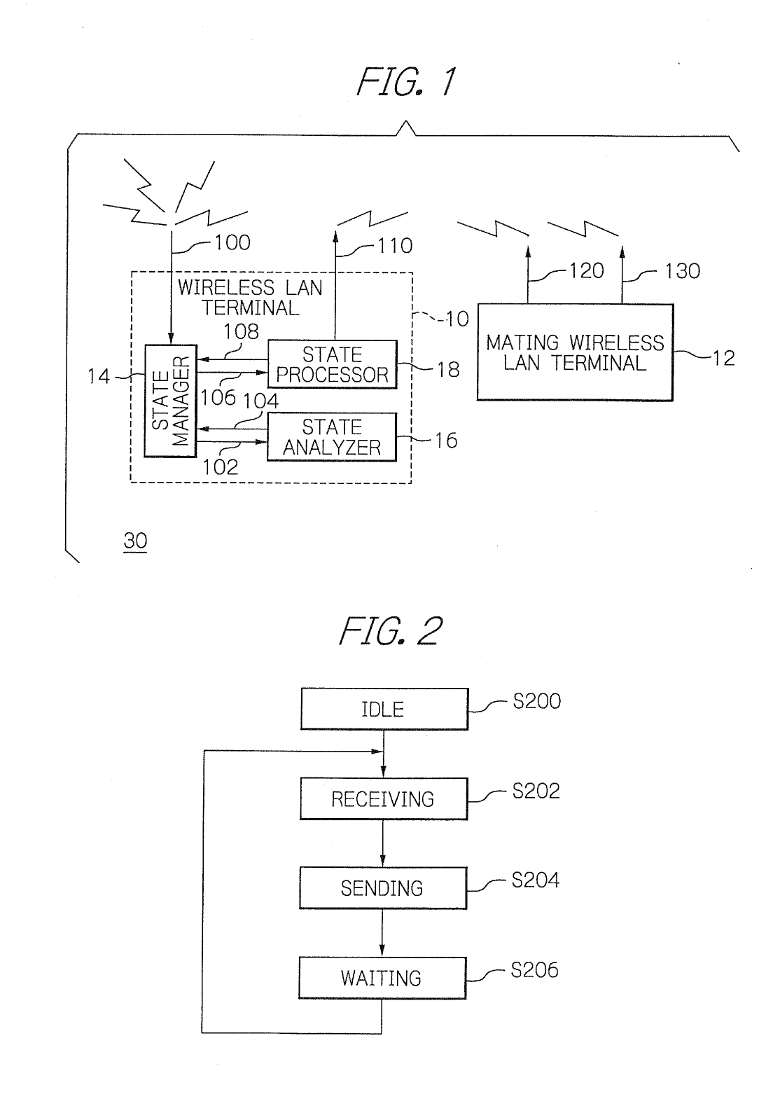

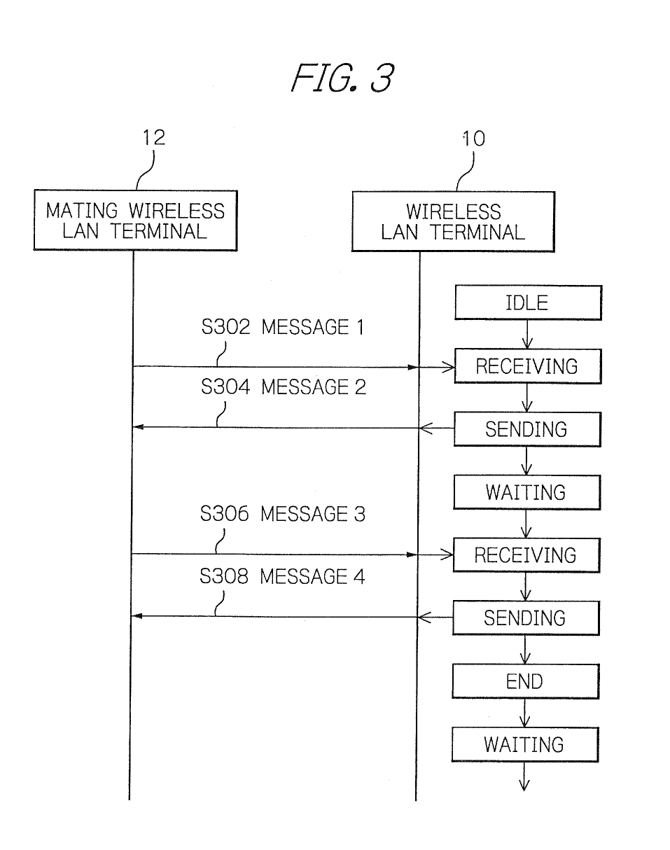

With reference to FIGS. 2 and 3, a detailed description will be given of how the communication state of the wireless LAN terminal 10 changes when messages are sent and received between the wireless LAN terminal 10 and the mating wireless LAN terminal 12.

First, in the wireless LAN terminal 10 of the preferred embodiment, initial setting is performed in preparation for receiving message signals (S200). The communication state is managed to the idle state.

The wireless LAN terminal 10 shares a pairwise master key (PMK) with the mating wireless LAN terminal 12 beforehand. If a four-way handshaking procedure is initiated, the wireless LAN terminal 10 receives a message signal 100 (message 1) such as a random number ANonce (Authenticator Nonce) from the mating wireless LAN terminal 12 (S302). At this stage, in the state manager 14 of the wireless LAN terminal 10, the communication state is switched from the idle state (S200) to the receiving state (S202).

In the wireless LAN terminal 10, when the communication state in the state manager 14 is in the receiving state, the information contents of the message signal 100 (message 1) are held in the state processor 18. In addition, a receiving-response message signal 110 (message 2) responding to the received message signal 100 (message 1) is generated in the state processor 18. That is, a random number SNonce (Supplicant Nonce) is generated. Further, based on the PMK, ANonce, and SNonce, a secret key PTK (Pairwise Transient Key) is generated. If the receiving-response signal 110 (message 2) is thus generated, the communication state in the state manager 14 of the wireless LAN terminal 10 is switched from the receiving state (S202) to the sending state (S204).

If the communication state of the wireless LAN terminal 10 is switched to the sending state (S204), then the receiving-response signal 110 (message 2) is sent from the state processor 18 to the mating wireless LAN terminal 12 (S304).

Upon completing the sending, the state processor 18 issues a sending-completion information signal 108. In response to the sending-completion information signal 108, the communication state in the state manager 14 of the wireless LAN terminal 10 is switched from the sending state (S204) to the waiting state (S206). At this stage, the four-way handshaking procedure between the wireless LAN terminal 10 and the mating wireless LAN terminal 12 is temporarily interrupted and the communication state is in the waiting state. This makes it possible to accept a task other than the four-way handshaking procedure for a connection with the mating wireless LAN terminal 12.

In the preferred embodiment, a message signal 100 (message 3) is sent from the mating wireless LAN terminal 12 (S306), and in the wireless LAN terminal 10 whose communication state is the waiting state (S206), the message signal 100 (message 3) is received in the state manager 14. The communication state is switched to the receiving state (S202).

The message signal 100 (message 3) is sent as a message signal 102 to the state analyzer 16, which in turn analyzes the message signal 102. After confirming on the basis of the analysis result 104 that the message signal 102 is normal, the state manager 14 sends a message information signal 106 to the state processor 18, which in turn generates a receiving-response message signal 110 (message 4) that responds to the message 3.

If the receiving-response message signal 110 (message 4) is generated, the communication state in the state manager 14 of the wireless LAN terminal 10 is switched from the receiving state (S202) to the sending state (S204), and the state processor 18 sends the receiving-response message signal 110 (message 4) to the mating wireless LAN terminal 12 (S308).

On completing the sending, the state processor 18 sends a sending-completion information signal 108, and in response to the signal 108, the communication state in the state manager 14 of the wireless LAN terminal 10 is switched from the sending state (S204) to the waiting state (S206).

Thus, a single four-way handshaking procedure is completed by sending and receiving signals four times.

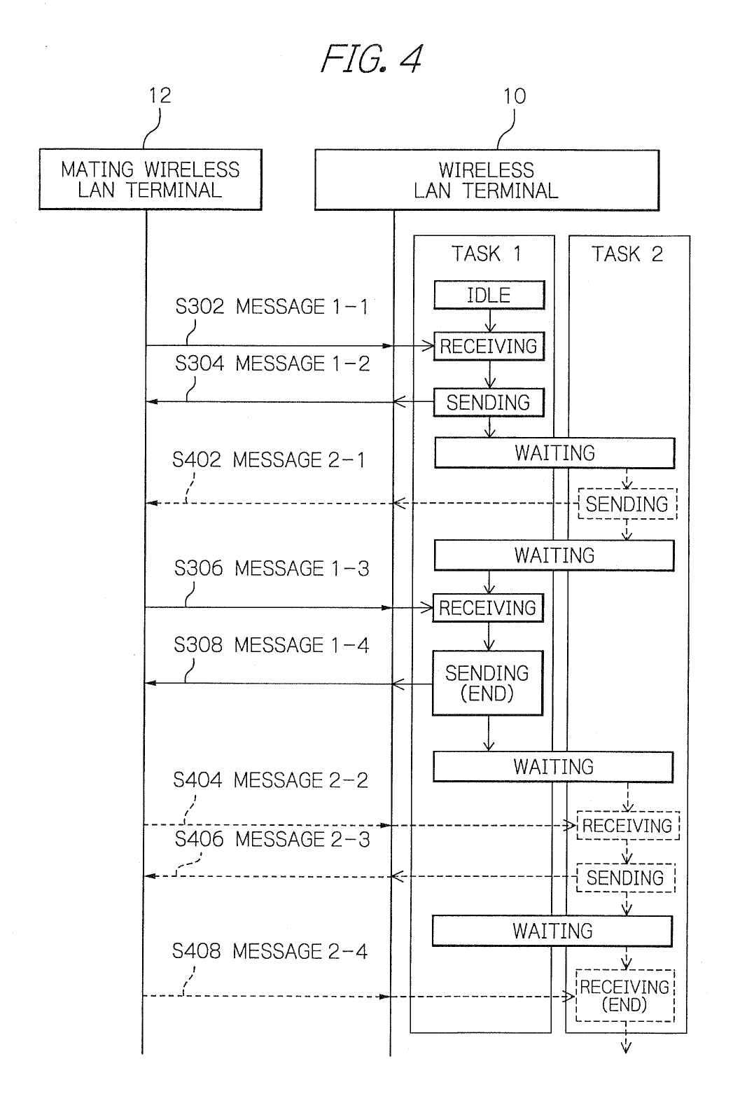

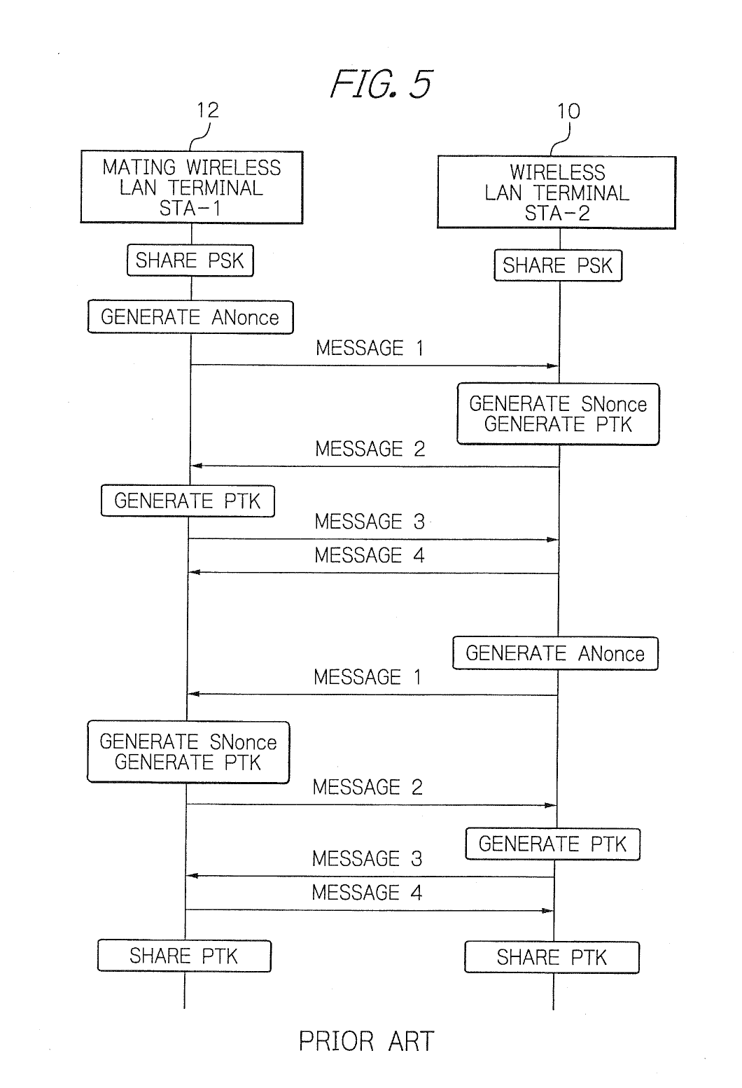

With reference to FIGS. 2 and 4, a detained description will be given in the case where the four-way handshaking procedure (first task 1) is interrupted by another task (second task 2).

In the wireless LAN terminals 10 and 12, as in the four-way handshaking procedure shown in FIG. 3, steps S302 and S304 in the first task 1 are carried out and then the communication state is switched to the waiting state (S206).

At this stage, the communication state of the wireless LAN terminal 10 is capable of accepting another processing procedure because the first task 1 is temporarily interrupted. For instance, as the second task 2, it becomes possible for the mating wireless LAN terminal 12 to start wireless communication, and a message 2-1 in the second task 2 is sent to the mating wireless LAN terminal 12 (S402).

In this example, the wireless LAN terminal 10 sends a message to the mating wireless LAN terminal 12. However, the wireless LAN terminal 10 may of course send or receive a message to or from another wireless LAN terminal.

On completing the sending, the state processor 18 sends a sending-completion information signal 108, and in response to the signal 108, the communication state in the state manager 14 of the wireless LAN terminal 10 is switched from the sending state (S204) to the waiting state (S206). At this stage, the second task 2 is temporarily interrupted, so a signal in another task can be sent and received and thus the first task 1 can be restarted. As a result, a message 1-3 (S306) sent from the wireless LAN terminal 12 is received in the state manager 14 of the wireless LAN terminal 10, and the communication state is switched from the waiting state (S206) to the receiving state (S202).

The message signal 100 (message 1-3) is sent as a message signal 102 to the state analyzer 16, which in turn analyzes the signal 102. After confirming on the basis of the analysis result 104 that the message signal 102 is normal, the state manager 14 sends a message information signal 106 to the state processor 18, which in turn generates a receiving-response message signal 110 (message 1-4) that responds to the message 1-3.

If the receiving-response message signal 110 (message 1-4) is generated, the communication state in the state manager 14 of the wireless LAN terminal 10 is switched from the receiving state (S202) to the sending state (S204), and the state processor 18 of the wireless LAN terminal 10 sends the message signal 110 (message 1-4) to the mating wireless LAN terminal 12 (S308).

On completing the sending, the state processor 18 sends a sending-completion information signal 108, and in response to the signal 108, the communication state in the state manager 14 of the wireless LAN terminal 10 is switched from the sending state (S204) to the waiting state (S206). At this stage, the first task 1 ends.

After the sending, the communication state in the state manager 14 of the wireless LAN terminal 10, in response to the sending-completion information signal 108 from the state processor 18, is switched to the waiting state (S206) Consequently, the second task 2 is again interrupted and the wireless LAN terminal 10 is able to send and receive a signal in another task.

In this example, a message signal 100 (message 2-2) in the second task 2 is sent from the mating wireless LAN terminal 12 (S404). It is received by the state manager 14 of the wireless LAN terminal 10 that is in the waiting state (S206), and the communication state of the wireless LAN terminal 10 is switched to the receiving state (S202).

The message signal 100 (message 2-2), as in the case of the message 1-3, is sent as a message signal 102 to the state analyzer 16, which in turn analyzes the signal 102. After confirming on the basis of the analysis result 104 that the message signal 102 is normal, the state manager 14 sends a message information signal 106 to the state processor 18, which in turn generates a receiving-response message signal 110 (message 2-3) that responds to the message 2-2.

If the receiving-respond message signal 110 (message 2-3) is generated, the communication state in the state manager 14 of the wireless LAN terminal 10 is switched from the receiving state (S202) to the sending state (S204), and the state processor 18 sends the message signal 110 (message 2-3) to the mating wireless LAN terminal 12 (S406).

After the sending, in response to the sending-completion information signal 108 from the state processor 18, the communication state in the state manager 14 of the wireless LAN terminal 10 is switched from the sending state (S204) to the waiting state (S206).

If a message signal 100 (message 2-4) in the second task 2 is sent from the mating wireless LAN terminal 12, the state manager 14 of the wireless LAN terminal 10 in the waiting state (S206) receives that signal (S408). At this stage, the second task 2 ends.

Thus, according to the instant embodiment, in the processing procedure for transmission and reception between the wireless LAN terminals 10 and 12, by providing temporary interruption, i.e. a waiting state, another processing procedure is accepted during the waiting time from when a signal is sent to when a response signal responding to that signal is received. This renders it possible to perform the two distinct processing procedures in parallel, so that communication between two or more wireless LAN terminals can be established with great efficiency. In addition, even when an unexpected message is received, the wireless LAN terminal 10 is able to take action such as retransmission and discarding of that message readily by managing its communication state.

The entire disclosure of Japanese patent application No. 2007-193076 filed on Jul. 25, 2007, including the specification, claims, accompanying drawings and abstract of the disclosure, is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A wireless LAN (Local Area Network) terminal for executing a four-way handshaking procedure when said wireless LAN terminal directly communicates with another wireless LAN terminal in a wireless ad hoc network mode, comprising:
a state processor which takes action in accordance with a communication state of said wireless LAN terminal, and, upon sending a message during the four-way handshaking procedure, issues sending-completion information that indicates completion of the sending; and
a state manager responsive to the sending-completion information for causing the communication state to be in a waiting state to thereby allow, during the four-way handshaking procedure, a message in processing other than the message sent during the four-way handshaking procedure to be sent or received.

2. The wireless LAN terminal in accordance with claim 1, wherein said state manager further manages a receiving state for receiving a message, a sending state for sending a message and an idle state as the communication state.

3. The wireless LAN terminal in accordance with claim 2, wherein said state processor accepts reception of a message from external in the idle state or the waiting state.

4. A method of executing a four-way handshaking procedure when a wireless LAN (Local Area Network) terminal directly communicates with another wireless LAN terminal in a wireless ad hoc network mode, comprising:
a state processing step of taking action in accordance with a communication state of the wireless LAN terminal, and issuing, upon sending a message during the four-way handshaking procedure, sending-completion information that indicates completion of the sending; and
a state managing step of causing, based on the sending-completion information, the communication state to be in a waiting state to thereby allow, during the four-way handshaking procedure, a message in processing other than the message sent during the four-way handshaking procedure to be sent or received.
